(19) United States
(12) Patent Application Publication
(10) Pub. No.: US 2021/0389217 A1
(43) Pub. Date: Dec. 16, 2021

(54) SPECIAL VERTICAL EMBEDDING BOX FOR TOMOGRAPHIC PLASTINATION

(71) Applicant: DALIAN MEDICAL UNIVERSITY, DALIAN (CN)

(72) Inventors: HONGJIN SUI, Dalian (CN); Jianfei Zhang, Dalian (CN)

(21) Appl. No.: 17/460,287

(22) Filed: Aug. 29, 2021

Related U.S. Application Data
(63) Continuation of application No. PCT/CN2021/073771, filed on Jan. 26, 2021.

(30) Foreign Application Priority Data
Feb. 10, 2020 (CN) 202010084586.X

(51) Int. Cl. G01N 1/36

(52) U.S. Cl. CPC G01N 1/36; G01N 2001/366; G01N 2001/362

(57) ABSTRACT

A special vertical embedding box for tomographic plastination comprises two panels oppositely provided and a sealing part provided in the two panels. The two panels are fixed by fixing pieces, and the sealing part comprises vertical sealing strips and a horizontal sealing strip that are connected between the two panels in a fixed manner. The horizontal sealing strip is provided between the lower portions of the two vertical sealing strips, thus forming a flat vertical space with an open upper end and the other three sides sealed. The embedding box is placed vertically during use, so that liquid medicine will not be spilled out. Acetone will escape from the top of the embedding box in the form of air bubbles during an infiltration process, so that there is no need to add polymers twice before curing, thus reducing process steps and drug consumption.

### TECHNICAL FIELD

The present invention relates to the field of biotechnology detection, and in particular to a special vertical embedding box for tomographic plastination.

### BACKGROUND ART

In the previous preparation of plastinated slices of biological tissues, it is necessary to prepare a mold similar to a shallow tray that is enclosed circumferentially. After the plastinated slices are dehydrated, they are put in polymers for infiltration, and the slices that have been infiltrated are placed into the shallow tray placed vertically. The mold is put in place, and polymers are re-injected. Then the mold is sealed circumferentially and placed horizontally, and curing and other processes are started. There exist the following problems in the preparation process: firstly, the traditional mold is inconvenient to use during the operation process, and it is easy to spill out liquid medicine; secondly, because the traditional mold is placed horizontally, it needs to be sealed circumferentially, such that bubbles and acetone gases that appear in the liquid medicine are not easy to be discharged, so that infiltration must be performed at first, and polymers need to be added twice before curing, thus causing a large consumption of polymers and a waste of medicine; and thirdly, in the use of the traditional mold, in a curing process, the mold can only be placed horizontally for curing, the temperature is controlled by air convection, the heat dissipation is not good, which is easy to cause explosive polymerization.

### SUMMARY OF THE INVENTION

The technical problem to be solved by the present invention is to overcome the shortcomings in the prior art and provide a special vertical embedding box for tomographic plastination.

The present invention is implemented by the following technical solutions:

A special vertical embedding box for tomographic plastination, characterized by comprising two panels oppositely provided and a sealing part provided in the two panels, wherein the sealing part comprises vertical sealing strips and a horizontal sealing strip that are connected between the two panels in a fixed manner, two vertical sealing strips are provided, and the horizontal sealing strip is provided between the lower portions of the two vertical sealing strips.

According to the above technical solution, preferably, the two panels are fixed by fixing pieces.

According to the above technical solution, preferably, the fixing pieces and the panels are detachably connected.

According to the above technical solution, preferably, the fixing pieces comprise a plurality of fixing clips, and the various fixing clips are respectively provided on two sides of the panels and the bottom edge of the panels.

According to the above technical solution, preferably, the panels are pieces of tempered glass.

According to the above technical solution, preferably, the material of the vertical sealing strips and the horizontal sealing strip is silica gel, neoprene or polyurethane.

According to the above technical solution, preferably, the vertical sealing strips and the horizontal sealing strip are connected end to end and integrally formed.

The beneficial effects of the present invention are as follows:

Firstly, the embedding box is placed vertically during use, and since the horizontal sealing strip is provided between the lower portions of the two vertical sealing strips, a flat vertical space is formed with one open upper end and the other three sides sealed, infiltration and curing processes for a tomographic specimen are completed in this vertical space. Compared with the previous solution, the sealing on one side is reduced. The exposed surface of the specimen is small, and the liquid medicine will not be spilled out because of the vertical placement. Secondly, since the upper end of the embedding box is not sealed, acetone will escape from the top of the embedding box in the form of air bubbles during the vacuum infiltration process, so that there is no need to add polymers twice before curing, thus reducing process steps and drug consumption. At the same time, the tiny bubbles generated during the curing process can also be discharged at any time, reducing the residual bubbles in the finished product. Thirdly, the vertically provided embedding box can be put into a water bath box for curing, by which the temperature is easily controlled, an explosive polymerization phenomenon will not occur, and the yield of finished products is high. In addition, because the specimen has panels as molds on both sides, the final product is smooth and does not deform.

### BRIEF DESCRIPTION OF THE DRAWINGS

FIG. 1 is a schematic front view of the structure of the present invention.

FIG. 2 is a schematic side view of the structure of the present invention.

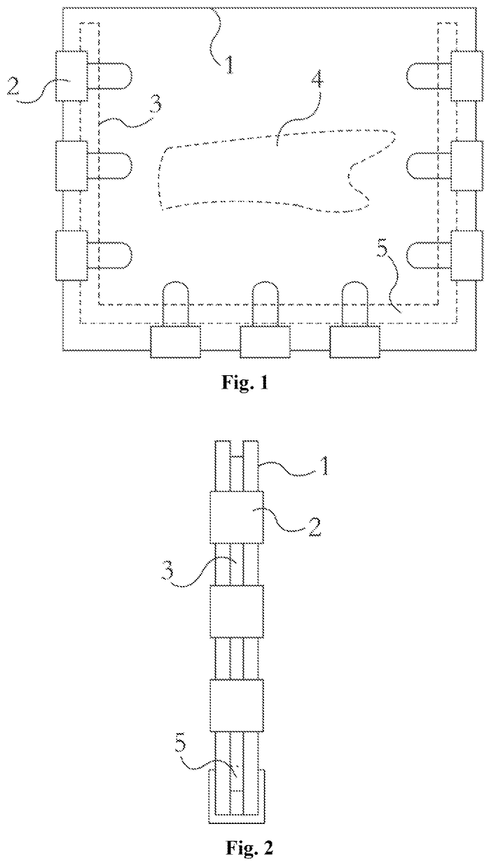

In the figures: 1. panel; 2. fixing clip; 3. vertical sealing strip; 4. specimen; 5. horizontal sealing strip.

### DETAILED DESCRIPTION OF EMBODIMENTS

In order to enable those skilled in the art to better understand the technical solutions of the present invention, the present invention will be further described in detail below with reference to the accompanying drawings and the preferred embodiments.

As shown in the figures, the present invention comprises two panels 1 oppositely provided and a sealing part provided in the two panels 1. The sealing part comprises vertical sealing strips 3 and a horizontal sealing strip 5 that are connected between the two panels 1 in a fixed manner. Two vertical sealing strips 3 are provided, and the horizontal sealing strip 5 is provided between the lower portions of the two vertical sealing strips 3. An embedding box is placed vertically during use, and infiltration and curing processes for a tomographic specimen 4 are completed in this vertical space. Compared with the previous solution, the sealing on one side is reduced. The exposed surface of the specimen 4 is small, and the liquid medicine will not be spilled out because of the vertical placement. Since the upper end of the embedding box is not sealed, acetone will escape from the top of the embedding box in the form of air bubbles during the vacuum infiltration process, so that there is no need to add polymers twice before curing, thus reducing process steps and drug consumption. At the same time, the tiny bubbles generated during the curing process can also be discharged at any time, reducing the residual bubbles in the finished product. The vertically provided embedding box can be put into a water bath box for curing, by which the temperature is easily controlled, an explosive polymerization phenomenon will not occur, and the yield of finished products is high. In addition, because the specimen 4 has panels 1 as molds on both sides, the final product is smooth and does not deform.

According to the above embodiment, preferably, the two panels 1 are fixed by fixing pieces. The fixing pieces are provided on two sides and the bottom edge of the two panels 1 to fix the surrounding three sides of the two panels 1 in an assisted manner, thus ensuring sealing.

According to the above embodiment, preferably, the fixing pieces and the panels 1 are detachably connected to facilitate removal of the double-sided tempered glass to obtain a finished slice after the liquid medicine is completely polymerized.

According to the above embodiment, preferably, the fixing pieces comprise a plurality of fixing clips 2, and the various fixing clips 2 are respectively provided on two sides of the panels 1 and the bottom edge of the panels 1.

According to the above embodiment, preferably, the panels 1 are pieces of tempered glass, which is convenient for an operator to observe the curing condition of the specimen 4 in the embedding box in real time.

According to the above embodiment, preferably, the material of the vertical sealing strips 3 and the horizontal sealing strip 5 is silica gel, neoprene or polyurethane. As a sealing material, silica gel has an outstanding high and low temperature resistance, and a good hydrophobicity, air permeability and insulating property. As a sealing material, neoprene has a good chemical resistance and adhesion, of which the use temperature range is −30° C. to ±120° C. As a sealing material, polyurethane has a good elasticity and an excellent mechanical property.

According to the above embodiment, preferably, the vertical sealing strips 3 and the horizontal sealing strip 5 are connected end to end and integrally formed. When the sealing part is made between the two panels 1, the vertical sealing strips 3 and the horizontal sealing strip 5 can also be connected end to end to form a single piece. The forming operation is simple, making the sealing part U-shaped, such that a flat vertical space is formed with one open upper end and the other three sides sealed.

During the use of the present invention, the vertical sealing strips 3 and the horizontal sealing strip 5 are coated on the surface of one piece of tempered glass. The two pieces of tempered glass are provided oppositely through the sealing part. The surrounding three sides of the two pieces of tempered glass are fixed by the fixing clips 2 in an assisted manner, thereby forming a flat vertical space with an open upper end and the other three sides sealed. The embedding box is placed vertically. The specimen 4 is placed between the two pieces of tempered glass from the open upper end, and then a pre-polymerized p45 liquid medicine is poured into the embedding box. After that, the embedding box is put into a vacuum box for vacuum infiltration, and then it is put in a water bath box for curing. After the liquid medicine is completely polymerized, the double-sided tempered glass is removed to obtain a finished slice. In addition, when making the embedding box, it is also possible to place the specimen 4 on the surface of one piece of tempered glass, and then coat the vertical sealing strips 3 and the horizontal sealing strip 5 on the surface of the tempered glass around the specimen 4. The two pieces of tempered glasses are provided oppositely through the sealing part.

The beneficial effects brought by the present invention are as follows: Firstly, the embedding box is placed vertically during use, and since the horizontal sealing strip 5 is provided between the lower portions of the two vertical sealing strips 3, a flat vertical space is formed with one open upper end and the other three sides sealed, infiltration and curing processes for a tomographic specimen 4 are completed in this vertical space. Compared with the previous solution, the sealing on one side is reduced. The exposed surface of the specimen 4 is small, and the liquid medicine will not be spilled out because of the vertical placement. Secondly, since the upper end of the embedding box is not sealed, acetone will escape from the top of the embedding box in the form of air bubbles during the vacuum infiltration process, so that there is no need to add polymers twice before curing, thus reducing process steps and drug consumption. At the same time, the tiny bubbles generated during the curing process can also be discharged at any time, reducing the residual bubbles in the finished product. Thirdly, the vertically provided embedding box can be put into a water bath box for curing, by which the temperature is easily controlled, an explosive polymerization phenomenon will not occur, and the yield of finished products is high. In addition, because the specimen 4 has panels 1 as molds on both sides, the final product is smooth and does not deform.

The above descriptions are merely preferred embodiments of the present invention. It should be noted that for those of ordinary skill in the art, several improvements and modifications can be made without departing from the principle of the present invention, and these improvements and modifications are also should be considered within the protection scope of the present invention.

1. A special vertical embedding box for tomographic plastination, wherein comprising two panels oppositely provided and a sealing part provided in the two panels, wherein the sealing part comprises vertical sealing strips and a horizontal sealing strip that are connected between the two panels in a fixed manner, two vertical sealing strips are provided, and the horizontal sealing strip is provided between the lower portions of the two vertical sealing strips.

2. The special vertical embedding box for tomographic plastination according to claim 1, wherein the two panels are fixed by fixing pieces.

3. The special vertical embedding box for tomographic plastination according to claim 2, wherein the fixing pieces and the panels are detachably connected.

4. The special vertical embedding box for tomographic plastination according to claim 3, wherein the fixing pieces comprise a plurality of fixing clips, and the various fixing clips are respectively provided on two sides of the panels and the bottom edge of the panels.

5. The special vertical embedding box for tomographic plastination according to claim 1, wherein the panels are pieces of tempered glass.

6. The special vertical embedding box for tomographic plastination according to claim 2, wherein the material of the vertical sealing strips and the horizontal sealing strip is silica gel, neoprene or polyurethane.

7. The special vertical embedding box for tomographic plastination according to claim 1, wherein the vertical sealing strips and the horizontal sealing strip are connected end to end and integrally formed.

8. The special vertical embedding box for tomographic plastination according to claim 2, wherein the vertical sealing strips and the horizontal sealing strip are connected end to end and integrally formed.

9. The special vertical embedding box for tomographic plastination according to claim 3, wherein the vertical sealing strips and the horizontal sealing strip are connected end to end and integrally formed.

10. The special vertical embedding box for tomographic plastination according to claim 4, wherein the vertical sealing strips and the horizontal sealing strip are connected end to end and integrally formed.

11. The special vertical embedding box for tomographic plastination according to claim 5, wherein the vertical sealing strips and the horizontal sealing strip are connected end to end and integrally formed.

12. The special vertical embedding box for tomographic plastination according to claim 6, wherein the vertical sealing strips and the horizontal sealing strip are connected end to end and integrally formed.
